(19) United States
(12) Patent Application Publication
(10) Pub. No.: US 2019/0176542 A1
(43) Pub. Date: Jun. 13, 2019

(54) A Noise Reducing Tread

(71) Applicant: Compagnie Generale Des Etablissements Michelin, Clermont-Ferrand (FR)

(72) Inventor: Takashi Tezuka, Tokyo (JP)

(21) Appl. No.: 16/304,490

(22) PCT Filed: May 31, 2017
(86) PCT No.: PCT/JP2017/020180

§ 371 Date: Nov. 26, 2018

(30) Foreign Application Priority Data
May 31, 2016 (JP) PCT/JP2016/066705

(51) Int. Cl. B60C 19/00; B60C 11/04

(52) U.S. Cl. CPC B60C 19/002; B60C 2011/1338; B60C 11/047

(57) ABSTRACT

The tread has a contact face intended to come into contact with ground during rolling and comprising at least one primary groove having depth D and being delimited by groove sidewalls. The groove sidewalls are axially connected by a groove bottom. The primary groove is provided with a closing device including at least two flexible fences. A first flexible fence has a thickness t1 extending from the groove bottom, and a second flexible fence has a thickness t2 extending from one of groove sidewalls toward the other. The flexible fences are distant each other in an orientation the primary groove extends with a gap g and overlap partly in sectional view of the primary groove. The gap g is at most equal to 1.0 mm. This tread provides further satisfactory reduction on groove resonance and productivity for manufacturing such tread.

### CROSS-REFERENCE TO RELATED APPLICATION

The present application claims priority to PCT International Patent Application Serial No. PCT/JP2016/066705, filed May 31, 2017, entitled “A NOISE REDUCING TREAD,” which claims priority to PCT/JP2016/066705, filed May 31, 2016.

### BACKGROUND OF THE INVENTION

### 1. Field of the Invention

The present invention relates to a tread for a tire, in particular to a tread for a tire having a closing device enable to attenuate a noise generated by groove resonance in a primary groove.

### 2. Related Art

A groove resonance is generated by occurrence of resonance in an air column defined between a groove in a tread and a road surface in contact with the tire. The frequency of this groove resonance is dependent on a length of the air column formed between groove and the road surface in the contact patch.

This groove resonance has a consequence in an interior noise and an exterior noise on a vehicle equipping such tires, a frequency of which interior and exterior noise is often at around 1 kHz where human ear is sensitive.

In order to reduce such groove resonance, it is known to provide a plurality of closing device in the form of a flexible fence made of rubber-based material and relatively thin in thickness in each primary groove. It is effective that each flexible fence covers all or at least major part of the sectional area in the primary groove. Each flexible fence can extend from a groove bottom, or be fixed onto at least one of a groove sidewall delimiting such primary groove. Because being relatively thin in thickness, each flexible fence has to bend for opening the primary groove section to flow water on the road surface, in particular on the wet road.

Thanks to such flexible fences, the length of the air column is reduced so as to be shorter than the total length of primary groove in a contact patch, which leads to change the frequency of groove resonance. This change of resonance frequency makes the sound generated by the groove resonance less sensitive to human ear.

For preserving function of drainage, in case of driving in rainy weather, it is necessary that such flexible fence bends in a suitable way under the action of the pressure of water for opening the section of the primary groove. Several solutions have been proposed using this type of closing device to reduce groove resonance of the primary groove.

EP0908330B1 discloses, in FIG. 4a, a tread having principal (primary) groove equipping with fence portions with three flexible fences, wherein two flexible fences extend inwardly from the opposite groove sidewalls, another flexible fence extends upwardly from the groove bottom which is offset from two flexible fences extending from the opposite groove sidewalls in an orientation the principal groove extends. However with such configuration, it is difficult to maintain satisfactory drainage capability, in particular when a groove depth is reduced with wear, as bending of the flexible fence extending from the groove bottom with hydrodynamic pressure occurs generally between middle part and bottom part of such flexible fence, and bending rigidity of such flexible fence increases with wear resulting disturbance of drainage. Moreover as there is always a gap between each the flexible fence not only in an orientation perpendicular to an orientation the principal groove extends but also in the orientation the principal groove extends, groove resonance attenuation capability is not satisfactory.

WO2013/072169A1 discloses, in FIG. 1, a tread having a groove providing with two flexible devices (flexible fences), both of which extend from each side of groove sidewalls, wherein the flexible devices are provided with a notch on their bottom wall. However, with such configuration, coverage of the section of the groove via the flexible fence becomes weak due to the notch and necessity to have a gap between two flexible fences in lateral orientation for securing bending capability and better productivity of the tread provided with the flexible fences.

### CITATION LIST

### Patent Literature

### [PTL 1]

EP0908330

### [PTL 2]

WO2013/072169

### Definitions

A “radial direction/orientation” is a direction/orientation perpendicular to axis of rotation of the tire. This direction/orientation corresponds to thickness orientation of the tread.

An “axial direction/orientation” is a direction/orientation parallel to axis of rotation of the tire.

A “circumferential direction/orientation” is a direction/orientation which is tangential to any circle centered on axis of rotation. This direction/orientation is perpendicular to both the axial direction/orientation and the radial direction/orientation.

A “tire” means all types of elastic tire whether or not subjected to an internal pressure.

A “tread” of a tire means a quantity of rubber material bounded by lateral surfaces and by two main surfaces one of which is intended to come into contact with ground when the tire is rolling.

A “groove” is a space between two rubber faces/sidewalls, which do not contact between themselves under usual rolling condition, connected by another rubber face/bottom. A groove has a width and a depth.

A “primacy groove” is a groove having relatively wider width as primarily responsible for liquid drainage. Often such primary groove extends towards generally circumferential orientation in a form of straight, zigzag and so on. The primary groove can also be understood as a groove extending in oblique orientation having relatively wider width as primarily responsible for liquid drainage.

A “contact patch” is a footprint of a tire mounted onto its standard rim as identified in tire standards such as ETRTO, JATMA or TRA, and inflated at its nominal pressure and under its nominal load.

### SUMMARY OF THE INVENTION AND ADVANTAGES

It is thus an object of the disclosure to provide a tread for a tire, which tread can provide further satisfactory reduction on groove resonance and productivity for manufacturing such tread.

The present disclosure provide a tread for a tire having a contact face intended to come into contact with ground during rolling and comprising at least one primary groove having depth D and being delimited by two opposite groove sidewalls, these groove sidewalls being axially connected by a groove bottom, the primary groove being provided with a plurality of closing device including at least two flexible fences, the closing device covering at least equal to 70% of sectional area of the primary groove, the at least two flexible fences of the closing device being at least one first flexible fence having thickness t1 and extending from the groove bottom in a radially outward orientation of the tire, and at least one second flexible fence having thickness t2 and extending from one of groove sidewall toward the other groove sidewall, the at least two flexible fences of the closing device being distant each other in an orientation the primary groove extends with a gap g, the first flexible fence and the second flexible fence overlap partly in sectional view of the primary groove, and the gap g is at most equal to 1.0 mm.

This arrangement provides further satisfactory reduction on groove resonance and productivity for manufacturing such tread.

According the above arrangement, the primary groove is provided with the plurality of closing device comprising at least two flexible fences as to cover at least equal to 70% of the cross sectional area of the primary groove. Therefore, the length of the air column of the primary groove formed with the road surface is different from that formed in case there is no closing device, and the peak of groove resonance is shifted to an outside of the frequency range audible to the human ear. As a result, groove resonance due to air column resonance of the primary groove can be improved.

Since the closing device includes at least two flexible fences, each the flexible fence can be relatively smaller for covering at least 70% of cross sectional area of the primary groove. As a result, productivity of the tread provided with the closing device can be improved.

Since the at least two flexible fences of the closing device are at least one first flexible fence having thickness t1 and extending from the groove bottom in a radially outward orientation of the tire, and at least one second flexible fence having thickness t2 and extending from one of groove sidewall toward the other groove sidewall, it is possible to cover as broader cross sectional area of the primary groove as effectively as possible by the closing device, while maintaining good productivity of the tread with the flexible fences as closing device, as the sectional area covered by each flexible fence can be reduced using simple tool for manufacturing the tread with the flexible fences which serve as the closing device.

Since the first flexible fence and the second flexible fence overlap partly in sectional view of the primary groove, it is possible to further effectively attenuate groove resonance due to air column resonance of the primary groove, as the sound wave generated by groove resonance has more difficulty in propagating between each the flexible fences of the closing device.

Since the at least two flexible fences of the closing device is distant each other in an orientation the primary groove extends with a gap g which is at most equal to 1.0 mm, a sound wave generated by groove resonance has difficulty in propagating through the gap between each the flexible fences of the closing device. As a result, groove resonance due to air column resonance of the primary groove can effectively be improved.

If the gap g is more than 1.0 mm, there is a risk of groove resonance attenuation capability degradation as the sound wave generated by groove resonance may propagate between each the flexible fences of the closing device. By setting this gap g at most equal to 1.0 mm, groove resonance due to air column can effectively be improved.

In another preferred embodiment, the gap g is at least equal to 0.05 mm and at most equal to 0.5 mm.

According to this arrangement, it is possible to further effectively attenuate groove resonance due to air column resonance of the primary groove while maintaining satisfactory drainage capability of the primary groove, as the sound wave generated by groove resonance has more difficulty in propagating through the gap between adjacent flexible fences of the closing device while ensuring enough gap between flexible fences for bending. Preferably this gap g is at least equal to 0.1 mm and at most equal to 0.3 mm, more preferably at least equal to 0.1 mm and at most equal to 0.2 mm.

In another preferred embodiment, the closing device includes one first flexible fence and two second flexible fences and each of the second flexible fences extends from each of opposite groove sidewalls.

According to this arrangement, it is possible to effectively cover as broader cross sectional area of the primary groove as possible by the closing device, while maintaining good productivity of the tread with the flexible fences which serve as closing device, as the sectional area covered by each flexible fence can be reduced using simple tool for manufacturing the tread with the flexible fences as the closing device, and to have higher flexibility of an arrangement of the flexible fences.

In another preferred embodiment, the two second flexible fences overlap partly in sectional view of the primary groove.

According to this arrangement, it is possible to further effectively attenuate groove resonance due to air column resonance of the primary groove, as the sound wave generated by groove resonance has more difficulty in propagating between each the flexible fences of the closing device.

In another preferred embodiment, the thickness t1 of the first flexible fence is different from the thickness t2 of the second flexible fence.

According to this arrangement, performance compromise by the flexible fences can be achieved. By making the thickness t1 of the first flexible fence thicker than the thickness t2 of the second flexible fence, it is possible to have a regular wear of the first flexible fence with tread wear by increased bending rigidity of the first flexible fence relative to the second flexible fence. Contrarily by making the thickness t1 of the first flexible fence thinner than the thickness t2 of the second flexible fence, it is possible to achieve easier bending of the first flexible fence even with reduced groove depth which results in further improvement on drainage capability.

### BRIEF DESCRIPTION OF THE DRAWINGS

Other characteristics and advantages of the disclosure arise from the description made hereafter in reference to the annexed drawings which show, as nonrestrictive examples, the embodiments of the disclosure.

In these drawings:

FIG. 1 is a schematic view of a portion of a tread for a tire according to a first embodiment of the present disclosure;

FIG. 2 is an enlarged schematic view showing a portion indicated as II in FIG. 1;

FIG. 3 is a schematic cross sectional view taken along line in FIG. 1;

FIG. 4 is an enlarged schematic view of a portion according to a second embodiment of the present disclosure;

FIG. 5 is a schematic cross sectional view according to the second embodiment of the present disclosure;

FIG. 6 is an enlarged schematic view of a portion according to a third embodiment of the present disclosure; and

FIG. 7 is a schematic cross sectional view according to the third embodiment of the present disclosure.

### DETAILED DESCRIPTION OF THE ENABLING EMBODIMENTS

Preferred embodiments of the present disclosure will be described below referring to the drawings.

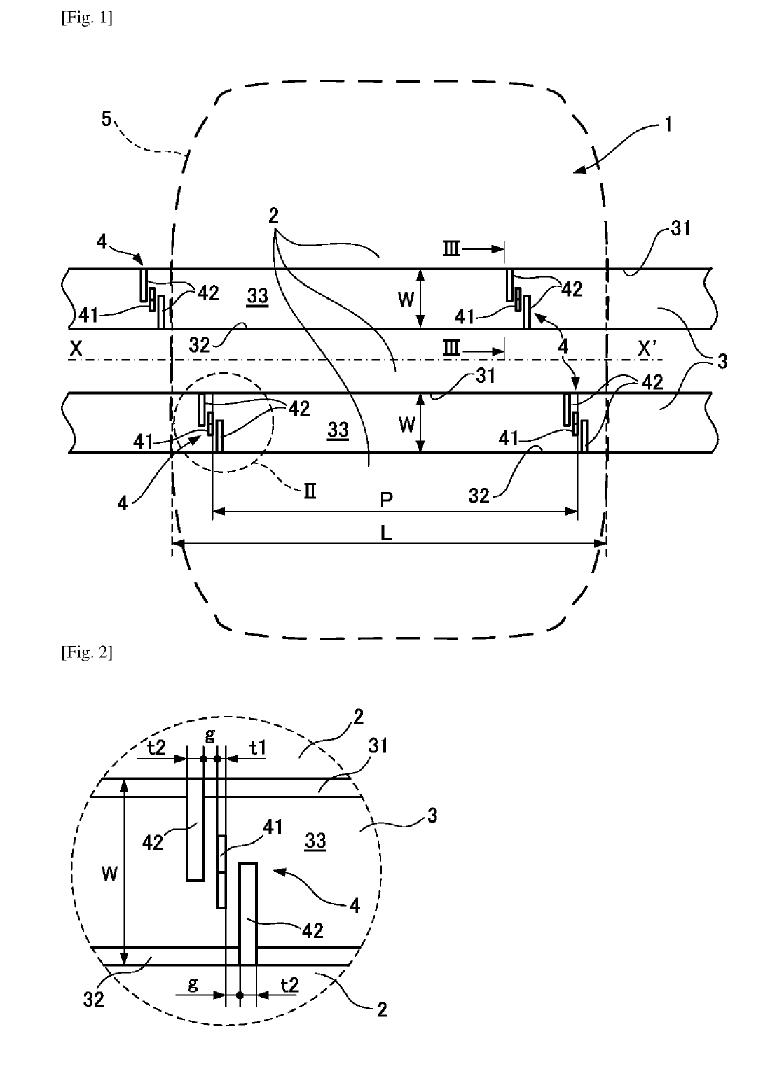

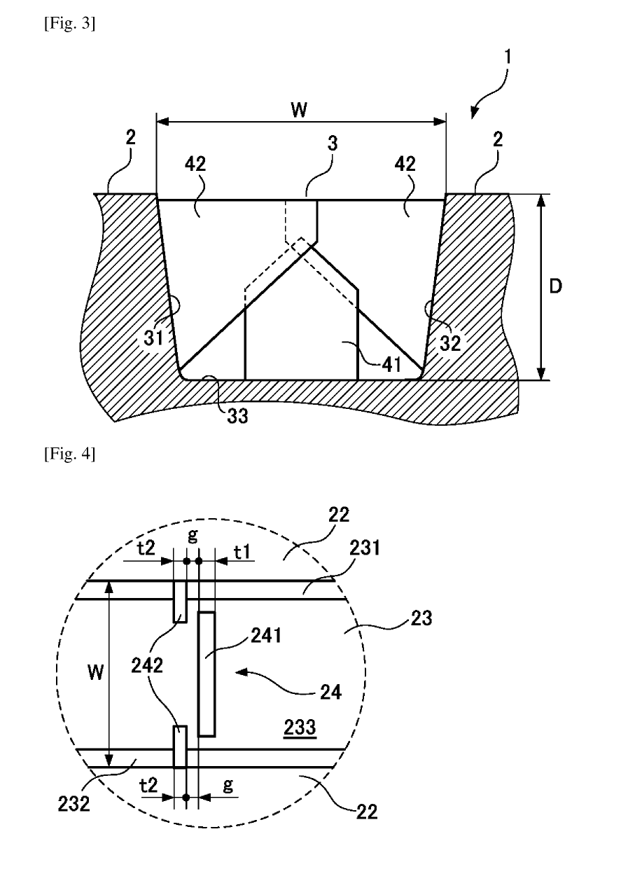

A tread 1 for a tire according to a first embodiment of the present disclosure will be described referring to FIGS. 1, 2 and 3. FIG. 1 is a schematic view of a portion of a tread 1 according to the first embodiment of the present disclosure. FIG. 2 is an enlarged schematic view showing a portion indicated as II in FIG. 1. FIG. 3 is a schematic cross sectional view taken along line in FIG. 1.

The tread 1 is a tread for a tire having dimension 225/45R17 and comprises a contact face 2 intended to come into contact with the ground during rolling, a plurality of primary groove 3 extending in a tire circumferential orientation indicated as XX′. The primary grooves 3 are delimited by two groove sidewalls 31, 32 facing each other and being connected by a groove bottom 33. The primary groove 3 has a width W at a level of the contact face 2 and a depth D (as shown in FIG. 3).

As shown in FIG. 1, a contact patch 5 has a contact patch length L in a tire circumferential orientation when the tire with the tread 1 is mounted onto its standard rim and inflated at its nominal pressure and its nominal load is applied. According to ‘ETRTO Standard Manual 2015’ the standard rim for this size is 7.5 J, the nominal pressure is 250 kPa and the nominal load is 615 kg.

As shown in FIG. 1, in the primary groove 3, a plurality of closing device 4 is provided. The closing device 4 comprises one first flexible fence 41 and two second flexible fences 42 for dividing an air column created between the ground and the primary groove 3 in the contact patch 5 during rolling. Each closing device 4 is spaced from each other by distance P in the tire circumferential orientation in the primary groove 3. The distance P is preferably shorter than the contact patch length L so that at least one closing device 4 is always located in the contact patch 5 during rolling in each primary groove 3.

The first flexible fence 41 has a thickness of t1 and extends from the groove bottom 33 of the primary groove 3 and two second flexible fences 42 have a thickness of t2 and extend from each of the opposite groove sidewalls 31, 32. Two second flexible fences 42 are offset each other in a circumferential orientation in the primary groove 3. The first flexible fence 41 is placed at a circumferential position between two second flexible fences 42, 42 and distant in circumferential orientation (an orientation the primary groove 3 extends) with a gap g which is at most equal to 1.0 mm, from both of the second flexible fences 42 in the primary groove 3, as shown in FIG. 2.

The thickness t1 of the first flexible fence 41 is thinner than the thickness t2 of the second flexible fence 42, as shown in FIG. 2. The first and the second flexiblea fences 41, 42 partly overlap in a circumferential orientation (in sectional view of the primary groove 3), and the two second flexible fences 42, 42 also overlap partly in a circumferential orientation (in sectional view of the primary groove 3). The first and the second flexible fences 41, 42 cover at least equal to 70% of the cross sectional area of the primary groove 3, as shown in FIG. 3.

As shown in FIG. 3, the first flexible fence 41 has a pentagon shape as to extend in radially outward orientation of the tread 1 from the groove bottom 33. The width of the first flexible fence 41 is less than the width W of the primary groove 3 and the height of the first flexible fence 41 is less than the depth D of the primary groove 3

Further, a radially inner edge of the second flexible fence 42 extends obliquely upwardly from the groove sidewall 31, 32 so as to form a triangular space defined by the radially inner edges of the two second flexible fences 42 and the groove bottom 33. A radially outer edge of the second flexible fence 42 extends substantially parallel to the contact face 2. The axial width of the second flexible fence 42 is less than the width W of the primary groove 3.

The tread 1 has the same structure as the conventional tread except for an arrangement regarding the closing device 4 and is intended to be applied to a conventional pneumatic radial tire and other non-pneumatic tire. Thus, description of the internal construction of the tread 1 will be omitted.

The primary groove 3 is provided with the plurality of closing device 4 each covering at least equal to 70% of the radial cross sectional area of the primary groove 3. Therefore, the length of the air column formed by the primary groove 3 in the contact patch 5 is shifted to a length whose groove resonance peak is outside of the frequency audible range for the human ear. Thus, groove resonance due to air column resonance of the primary groove 3 can be harmless.

The flexible fences of the closing device 4 are provided so as to be distant each other with the gap g which is at most equal to 1.0 mm in an orientation along which the primary groove 3 extends. Therefore, it is possible to effectively improve groove resonance due to air column as a sound wave generated by groove resonance has difficulty in propagating between each the flexible fences of the closing device 4. This effect of improving groove resonance due to air column is further emphasized by setting this gap g at least equal to 0.05 mm and at most equal to 0.5 mm while ensuring enough gap between flexible fences to bend. Preferably this gap g is at least equal to 0.1 mm and at most equal to 0.3 mm, and more preferably at least equal to 0.1 mm and at most equal to 0.2 mm.

The closing device 4 includes one first flexible fence 41 and two second flexible fences 42 and each of the second flexible fences 42 extends from each of opposite groove sidewalls 31, 32. Therefore, it is possible to cover as broader cross sectional area of the primary groove 3 as effectively as possible by the closing device 4, while maintaining good productivity of the tread 1 with the flexible fences as closing device 4, as the sectional area covered by each flexible fence can be reduced using simple tool for manufacturing the tread 1 with the flexible fences as the closing device 4, and to have higher flexibility of an arrangement of the first and the second flexible fences.

The first flexible fence 41 and the second flexible fence 42 of the closing device 4 overlap partly in a circumferential orientation (in sectional view of the primary groove 3). Also, two second flexible fences 42 of the closing device 4 overlap partly in a circumferential orientation (in sectional view of the primary groove 3). Therefore, it is possible to further effectively attenuate groove resonance due to air column resonance of the primary groove 3, as the sound wave generated by groove resonance has more difficulty in propagating between each the flexible fences of the closing device 4.

The thickness t1 of the first flexible fence 41 is thinner than the thickness t2 of the second flexible fence 42. It is possible to achieve easier bending of the first flexible fence 41 even when the groove depth decreases, which results further improvement on drainage capability. Both the thickness t1 of the first flexible fence 41 and the thickness t2 of the second flexible fence 42 is preferably less than or equal to 1.5 mm, more preferably between 1.0 mm and 0.2 mm, and a difference between two thicknesses t1 and t2 is preferably less than or equal to 1.0 mm, more preferably less than or equal to 0.5 mm.

The gap g between the flexible fences 41, 42 of the closing device 4 may have different value position by position, and the thickness t2 of the second flexible fence 42 may have different thickness one another.

A tread 21 according to a second embodiment of the present disclosure will be described referring to FIGS. 4 and 5. FIG. 4 is an enlarged schematic view of a portion according to the second embodiment of the present disclosure. FIG. 5 is a schematic cross sectional view according to the second embodiment of the present disclosure. The constitution of this second embodiment is similar to that of the first embodiment other than the arrangement shown in FIGS. 4 and 5, thus description will be made referring to FIGS. 4 and 5.

In the second embodiment, a closing device 24 comprises one first flexible fence 241 having a thickness of t1 and extending from a groove bottom 233 of a primary groove 23 and two second flexible fences 242 having a thickness of t2 and extending from each of opposite groove sidewalls 231, 232. Two second flexible fences 242 are substantially in line each other in an axial orientation in the primary groove 23. The first flexible fence 241 is placed as to be distant in circumferential orientation (an orientation along which the primary groove 23 extends) from the second flexible fences 242 with a gap g which is at most equal to 1.0 mm, in the primary groove 23.

The thickness t1 of the first flexible fence 241 is thicker than the thickness t2 of the second flexible fence 242, as shown in FIG. 4. The first and the second flexible fences 241, 242 partly overlap in a circumferential orientation (in sectional view of the primary groove 23). The first and the second flexible fences 241, 242 cover at least equal to 70% of the cross sectional area of the primary groove 23, as shown in FIG. 5. The width of the first flexible fence 241 is less than the width W of the primary groove 23. Side portions of the second flexible fences 242 facing to the primary groove 23 overlap the each side of the first flexible fence 241.

As shown in FIG. 5, the first flexible fence 241 has a rectangular shape as to extend in radially outward orientation of the tread 21 from the groove bottom 233 to substantially same level as a contact face 22, and covers major part of the primary groove 23.

Further, a radially inner edge of the second flexible fence 242 extends obliquely upwardly from the groove sidewall 231, 232 so as to form a triangular space thereunder with the groove bottom 233. A radially outer edge of the second flexible fence 242 extends substantially parallel to the contact face 22 at radially inward level from the contact face 22 and covers relatively minor part of the primary groove 23 without overlapping each other in circumferential orientation (in sectional view of the primary groove 23).

The flexible fences of the closing device 24 are provided so as to be distant from each other with the gap g which is at most equal to 1.0 mm in an orientation the primary groove 23 extends. Therefore, it is possible to effectively improve groove resonance due to air column as a sound wave generated by groove resonance has difficulty in propagating between each the flexible fences of the closing device 24. This effect of improving groove resonance due to air column is further emphasized by setting this gap g at least equal to 0.05 mm and at most equal to 0.5 mm while ensuring enough gap between flexible fences to bend. Preferably this gap g is at least equal to 0.1 mm and at most equal to 0.3 mm, and more preferably at least equal to 0.1 mm and at most equal to 0.2 mm.

The closing device 24 includes one first flexible fence 241 and two second flexible fences 242 and each of the second flexible fences 242 extends from each of opposite groove sidewalls 231, 232. Therefore, it is possible to effectively cover as broader cross sectional area of the primary groove 23 as possible by the closing device 24, while maintaining good productivity of the tread 21 with the flexible fences as closing device 24, as the sectional area covered by each flexible fence can be reduced using simple tool for manufacturing the tread 21 with the flexible fences as the closing device 24, and to have higher flexibility of an arrangement of the first and the second flexible fences.

The first flexible fence 241 and the second flexible fence 242 of the closing device 24 overlap partly in a circumferential orientation (in sectional view of the primary groove 23). Therefore, it is possible to further effectively attenuate groove resonance due to air column resonance of the primary groove 23, as the sound wave generated by groove resonance has more difficulty in propagating between each the flexible fences of the closing device 24.

The thickness t1 of the first flexible fence 241 is thicker than the thickness t2 of the second flexible fence 242. Therefore it is possible to have a regular wear of the first flexible fence 241 with tread wear by increased bending rigidity of the first flexible fence 241 relative to the second flexible fence 242. Both the thickness t1 of the first flexible fence 241 and the thickness t2 of the second flexible fence 242 is preferably less than or equal to 1.5 mm, more preferably between 1.0 mm and 0.2 mm, and a difference between two thicknesses t1 and t2 is preferably less than or equal to 1.0 mm, more preferably less than or equal to 0.5 mm.

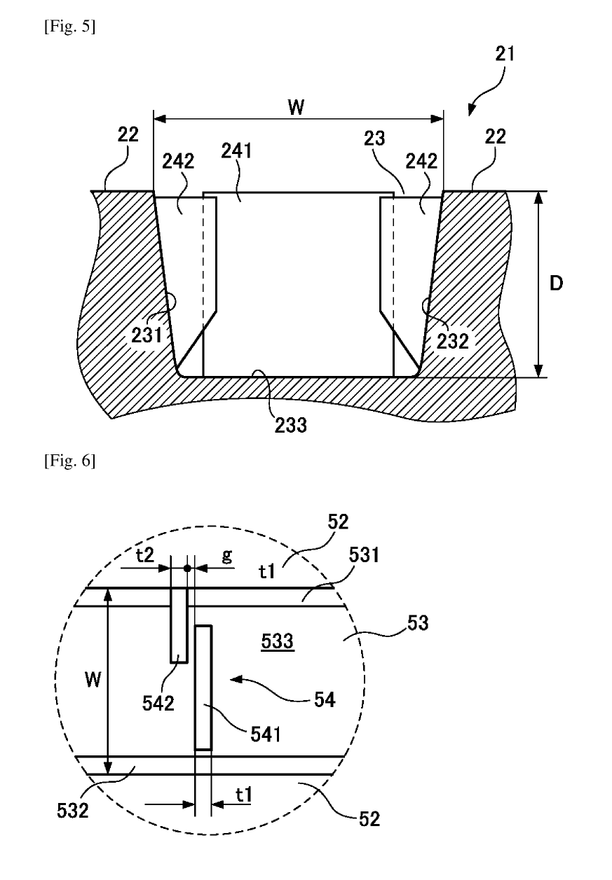

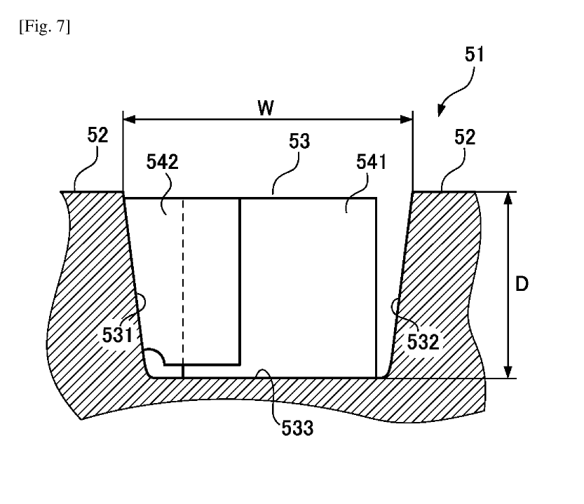

A tread 51 according to a third embodiment of the present disclosure will be described referring to FIGS. 6 and 7. FIG. 6 is an enlarged schematic view of a portion according to the third embodiment of the present disclosure. FIG. 7 is a schematic cross sectional view according to the third embodiment of the present disclosure. The constitution of this third embodiment is similar to that of the first embodiment other than the arrangement shown in FIGS. 6 and 7, thus description will be made referring to FIGS. 6 and 7.

In the third embodiment, a closing device 54 comprises one first flexible fence 541 having a thickness t1 and extending from a groove bottom 533 of the primary groove 53 and one second flexible fence 542 having a thickness t2 and extending from one groove sidewall 531. The thickness t1 of the first flexible fence 541 is substantially equal to the thickness t2 of the second flexible fence 542, as shown in FIG. 6. The first flexible fence 541 is placed as to be distant in circumferential orientation (an orientation the primary groove 53 extends) from the second flexible fence 542 with a gap g which is at most equal to 1.0 mm, in the primary groove 53.

As shown in FIG. 7, the first flexible fence 541 has a rectangular shape as to extend in radially outward orientation of the tread 51 from the groove bottom 533, and a radially outer edge of the first flexible fence 541 offsets radially inwardly from the level of the contact face 52, and the first flexible fence 541 covers major part of the primary groove 53.

Further, a radially inner edge of the second flexible fence 542 extends substantially parallel to the groove bottom 533 and quadrantly notched at connecting part to the groove sidewall 531. A radially outer edge of the second flexible fence 542 extends substantially parallel to the contact face 52 at radially inwardly offset level from the level of the contact face 52 and the second flexible fence 542 covers relatively minor part of the primary groove 53. The first and the second flexible fences 541, 542 cover at least equal to 70% of the cross sectional area of the primary groove 53, as shown in FIG. 7.

The flexible fences of the closing device 54 are provided so as to be distant from each other with the gap g which is at most equal to 1.0 mm in an orientation along which the primary groove 53 extends. Therefore, it is possible to effectively improve groove resonance due to air column as a sound wave generated by groove resonance has difficulty in propagating between each the flexible fences of the closing device 54. This effect of improving groove resonance due to air column is further emphasized by setting this gap g at least equal to 0.05 mm and at most equal to 0.5 mm while ensuring enough gap between flexible fences to bend. Preferably this gap g is at least equal to 0.1 mm and at most equal to 0.3 mm, and more preferably at least equal to 0.1 mm and at most equal to 0.2 mm.

The closing device 54 includes one first flexible fence 541 and one second flexible fence 542 and the second flexible fence 542 extends from one of the groove sidewall 531. Therefore, it is possible to cover as broader cross sectional area of the primary groove 53 as effectively as possible by the closing device 54, while maintaining good productivity of the tread 51 with the flexible fences as closing device 54, as the sectional area covered by each flexible fence can be reduced using simple tool for manufacturing the tread 51 with the flexible fences as the closing device 54, and to have higher flexibility of an arrangement of the first and the second flexible fences.

The first flexible fence 541 and the second flexible fence 542 of the closing device 54 overlap partly in a circumferential orientation (in sectional view of the primary groove 53). Therefore, it is possible to further effectively attenuate groove resonance due to air column resonance of the primary groove 53, as the sound wave generated by groove resonance has more difficulty in propagating between each the flexible fences of the closing device 54.

In order to confirm the effect of the present disclosure, three types of pneumatic tires of Example to which the present disclosure is applied and another type of pneumatic tire of Comparative Example were prepared. An internal construction of these tires was typical radial tire construction for passenger car tire.

The Examples were pneumatic tires having a tread as shown in FIG. 3 described in the above embodiment with three different gap g between each the flexible fence of the closing device. The Comparative Example was a pneumatic tire having a tread as shown in FIG. 3 with gap g out of the range of the present disclosure, and Reference was a pneumatic tire without having the closing device.

The tire dimension of the Examples, Comparative Example and Reference were all 205/55R16, mounted onto a rim of 6.5 J×16, and inflated to 180 kPa.

### Noise Test:

A sound pressure level of the unused test tires mounted onto abovementioned rim, inflated to abovementioned internal pressure were measured while applying a load of 452 daN, running 90 kph on a drum of 2.7 m in diameter having ISO surface in a semi-anechoic chamber, via a microphone installed axially 1 m outward from a center of tire contact, radially 0.2 m backward from a tire rolling axis and 0.32 m in height. The data acquired through the measurements were processed to calculate an absorption level of a sound at groove resonance frequency. The results are shown in table 1. In this table 1, results are represented by an index of 100 for Reference, higher the number indicates better the noise performance.

TABLE 1

| | | | | Com- | |
|---|---|---|---|---|---|
| | | | | parative | |
| | Example 1 | Example 2 | Example 3 | Example | Reference |
| Gap g (mm) | 1.0 | 0.5 | 0.2 | 2.0 | — |
| Noise | 106 | 107 | 108 | 103 | 100 |
| performance | | | | | |
| (index) | | | | | |

As seen from table 1, the Example tires show improvement on noise performance.

The disclosure is not limited to the examples described and represented and various modifications can be made there without leaving its framework.

### REFERENCE SIGNS LIST

1, 21, 51 tread
2, 22, 52 contact face
3, 23, 53 primary groove
31, 231, 531 groove sidewall of the primary groove
32, 232, 532 groove sidewall of the primary groove
33, 233, 533 groove bottom of the primary groove
4, 24, 54 closing device
41, 241, 541 first flexible fence
42, 242, 542 second flexible fence
5 contact patch

What is claimed is:

1. A tread for a tire having a contact face intended to come into contact with ground during rolling and comprising at least one primary groove having depth D and being delimited by two opposite groove sidewalls, these groove sidewalls being axially connected by a groove bottom, the primary groove being provided with a plurality of closing device including at least two flexible fences, the closing device covering at least equal to 70% of sectional area of the primary groove, the at least two flexible fences of the closing device being at least one first flexible fence having thickness t1 and extending from the groove bottom in a radially outward orientation of the tire, and at least one second flexible fence having thickness t2 and extending from one of groove sidewall toward the other groove sidewall, the at least two flexible fences of the closing device being distant from each other in an orientation along which the primary groove extends with a gap g,
the first flexible fence and the second flexible fence overlapping partly in a sectional view of the primary groove, and the gap g is at most equal to 1.0 mm, and
the closing device including one first flexible fence and two second flexible fences and each of the second flexible fences extending from each of opposite groove sidewalls.

2. The tread according to claim 1, wherein the gap g is at least equal to 0.05 mm and at most equal to 0.5 mm.

3. (canceled)

4. The tread according to claim 2, wherein the two second flexible fences overlap partly in the sectional view of the primary groove.

5. The tread claim 1, wherein the thickness t1 of the first flexible fence is different from the thickness t2 of the second flexible fence.

6. (canceled)
